(19) United States
(12) Patent Application Publication
(10) Pub. No.: US 2011/0229276 A1
(43) Pub. Date: Sep. 22, 2011

(54) METHOD AND APPARATUS FOR SEPARATING PARTICULATE SOLIDS FROM A GAS STREAM

(76) Inventors: Thomas Eder, Traun (AT); Robert Millner, Loosdorf (AT); Norbert Rein, Wien (AT); Johannes Leopold Schenk, Linz (AT)

(21) Appl. No.: 13/125,859

(22) PCT Filed: Sep. 29, 2009
(86) PCT No.: PCT/EP2009/062605

§ 371 Date: Jun. 3, 2011

(30) Foreign Application Priority Data
Oct. 23, 2008 (AT) A1659/2008

(51) Int. Cl. B65G 53/66; B65G 53/60

(52) U.S. Cl. 406/10; 406/172

(57) ABSTRACT

A method and a device for separating particulate solids from a gas flow, particularly a carrier gas flow for transporting the particulate solids, has a transport line (2) that leads into a separating chamber (5), a connected dry filter (9) for separating dusts and/or fine particulate solids, a discharge line (12) for conducting away the cleaned gas flow, and a storage container (1) for holding the separated particulate solids. The dry filter is equipped with backwash units for cleaning the dry filter.

### CROSS-REFERENCE TO RELATED APPLICATIONS

This application is a U.S. National Stage Application of International Application No. PCT/EP2009/062605 filed Sep. 29, 2009, which designates the United States of America, and claims priority to Austrian Application No. A1659/2008 filed Oct. 23, 2008. The contents of which are hereby incorporated by reference in their entirety.

### TECHNICAL FIELD

The invention relates to an apparatus for separating particulate solids from a gas stream, in particular a carrier gas stream for transporting the particulate solids, comprising at least one transport line which issues into a separating chamber, a connected dry filter for separating dusts and/or finely particulate solids, with a discharge line for discharging the cleaned gas stream, and a storage container for holding the separated particulate solids.

The invention also relates to a method for separating particulate solids from a gas stream, in particular a carrier gas stream for transporting the particulate solids.

### BACKGROUND

It is known from the prior art that carrier gas serving for pneumatically transporting particulate solids is cleaned, after the transported solids have been separated, by means of a hot cyclone and then by means of a wet scrubber. This has the disadvantage that, in addition to the high water consumption, a large amount of slurry is also produced, and this can only be supplied for further utilization by means of complicated methods.

It is known from JP 05-076803 A to arrange a filter in a cyclone, wherein coarse separation in the cyclone is followed by fine separation in the filter. The material separated here can be further processed.

Similarly, it is known from WO 94/11283 to separate dusts from a carrier gas and to supply the dusts separated in the process to an open vessel or to clean the carrier gas in the cyclone and a bag filter.

### SUMMARY

According to various embodiments, a method and an apparatus can be provided which make it possible for a gas stream to be cleaned reliably and cost-effectively and also allow simple material utilization and further processing of the dust.

According to an embodiment, an apparatus for separating particulate solids from a carrier gas stream for transporting the particulate solids, may comprise at least one transport line which issues tangentially into a separating chamber, a connected dry filter for separating dusts and/or finely particulate solids, with a discharge line for discharging the cleaned gas stream, and a storage container for holding the separated particulate solids, wherein the dry filter comprises backwashing devices for separating the filter cake from the dry filter, wherein the dry filter is connected to the storage container in such a manner that the filter cake passes into the storage container, wherein the storage container is a charging container for charging the particulate solids and/or the filter cake into an agglomerating device or into a melting unit for processing the particulate solids, wherein the separating chamber is designed in such a manner that the separation takes place not only owing to gravitational force, but also owing to the tangential flow, in a manner similar to that in a cyclone, and wherein the carrier gas stream consists of process gas from a direct reduction, wherein ports for purging the particulate solids and the filter cake with inert gas are provided in the storage container.

According to a further embodiment, the transport line may have a controller and/or a valve, in particular an on/off valve, for controlling the volumetric flow or the duration of the gas stream and of the particulate solids present therein. According to a further embodiment, the dry filter may be positioned on the storage container, wherein the separating chamber is formed by the storage container. According to a further embodiment, the dry filter can be arranged alongside the storage container, wherein the separating chamber is formed by the lower part of the dry filter. According to a further embodiment, the dry filter may have a discharge line for transporting the separated particulate solids and/or the filter cake away into the storage container. According to a further embodiment, the dry filter can be a sintered porous metal filter, a ceramic filter or a bag filter. According to a further embodiment, pulse lines and pressure measurement devices for measuring the pressures upstream and downstream of the dry filter or for determining a differential pressure can be provided, wherein the differential pressure is supplied to a controller and used to control the backwashing device. According to a further embodiment, a controller for controlling an alternate supply of the particulate solids by means of the gas stream and the supply of purge gas can be provided.

According to another embodiment, in a method for separating particulate solids from a carrier gas stream for transporting particulate solids, wherein these solids are iron-containing primary products for the production of pig iron and steel, the gas stream is formed from non-oxidizing process gas from a direct reduction and is initially fed by means of a transport line into a separating chamber, where at least partial separation of the particulate solids takes place owing to gravitational force, wherein the separating chamber is designed in such a manner that the separation also takes place owing to a tangentially forming flow, in a manner similar to that in a cyclone, and then the at least partially cleaned gas stream is supplied to a connected dry filter for separating the remaining solids in dust and/or finely particulate form, wherein the cleaned gas stream is discharged from the dry filter by means of a discharge line and the separated particulate solids are supplied to a storage container, wherein the filter cake is separated from the filter by a non-oxidizing backwashing gas and supplied to the storage container, wherein the particulate solids and/or the filter cake are purged with inert gas via ports in the storage container and charged from the storage container into an agglomerating device and/or a melting unit for processing the particulate solids and/or the filter cake.

According to a further embodiment of the method, a backwashing gas, in particular nitrogen, can be fed into the dry filter under pressure, in particular 3 to 6 bar, by means of backwashing devices in order to remove the filter cake, wherein the removed filter cake is supplied to the storage container. According to a further embodiment of the method, during the cleaning phase, starting with the point in time from which the purge gas is fed into the dry filter, the supply of the gas stream and of the particulate solids can be blocked by means of a controller and/or a valve. According to a further embodiment of the method, the particulate solids can be at least partially reduced iron, iron agglomerates or sponge iron, in particular in finely particulate form. According to a further embodiment of the method, the gas stream can be formed from reduction gas and/or nitrogen or a mixture thereof. According to a further embodiment of the method, a differential pressure can be measured at the dry filter, and the backwashing of the dry filter is initiated by means of a controller if a predefined differential pressure level is exceeded. According to a further embodiment of the method, the particulate solids can be supplied by means of the gas stream in a batchwise manner, in particular cyclically, and in a controlled manner alternating with the cleaning cycle starting with the supply of purge gas.

### BRIEF DESCRIPTION OF THE DRAWINGS

FIG. 1 depicts a dry filter according to various embodiments in a specific arrangement directly above a storage container for particulate solids.

### DETAILED DESCRIPTION

The apparatus according to various embodiments combines the pneumatic transportation of particulate solids by means of a gas stream and the cleaning of the gas stream after the particulate solids have been separated, and a significantly simpler apparatus is proposed. The mixture of gas stream and particulate solids initially passes, in particular tangentially, into the separating chamber, such that the particulate solids are largely separated owing to gravitational force and only dusts or else finely particulate solids pass into the dry filter, where they are separated. The separating chamber is designed here in such a manner that the separation takes place not only owing to gravitational force, but also owing to the tangential flow, in a manner similar to that in a cyclone.

On account of the large quantities of dusts and finely particulate solids which arise in process gases in reduction metallurgy, e.g. during the direct reduction of iron ores, cleaning devices for such gases have to be configured in such a manner that it is also possible to reliably process said very large quantities. In order to ensure reliable operation, the dry filter comprises backwashing devices for separating the filter cake from the dry filter. The dry filter here is connected to the storage container in such a manner that the filter cake passes into the storage container. As a result of the backwashing of the filter device, the filter can be cleaned and thus returned to the initial operating state, wherein the solids deposited on the filter are removed as a filter cake from the dry filter and can be introduced into the storage container. It is therefore no longer necessary to discard the filter cake and supply it for separate utilization or separate conditioning.

The storage container is a charging container for charging the particulate solids and/or the filter cake into a compacting device, in particular an agglomerating device, or into a metallurgical unit, in particular a melting unit, for processing the particulate solids. It is therefore possible to introduce the particulate feed materials directly from the transport line into the separating chamber and into the storage container, with no contact being made with the surrounding atmosphere. This makes direct further processing possible, if appropriate after preceding compaction, and therefore for example separate devices for transporting or for storing the particulate solids are no longer required.

Since the often hot particulate solids and the hot filter cake do not come into contact with the atmosphere, but only with the gas stream, undesirable oxidation processes, e.g. with air, do not occur either.

According to an embodiment, the transport line has a controller and/or a valve, in particular an on/off valve, for controlling the volumetric flow or the duration of the gas stream and of the particulate solids present therein. In order to make it possible to ensure optimum operation of the apparatus, it is necessary to control the volumetric flow or the opening times or to keep these in a control range or time range.

According to a configuration of the apparatus, the dry filter is positioned on the storage container, wherein the separating chamber is formed by the storage container. This makes it possible to obtain a very compact apparatus, and therefore separate devices for transporting the filter cake into the storage container can be dispensed with. According to various embodiments, the dry filter is arranged alongside the storage container, wherein the separating chamber is formed by the lower part of the dry filter. This specific configuration may be advantageous, for example, in the case of retroactive installation of the apparatus according to various embodiments or else in the case of confined space conditions.

According to a further configuration of the apparatus n, the dry filter has a discharge line for transporting the separated particulate solids and/or the filter cake away into the storage container. If the dry filter is arranged alongside the storage container, this makes it possible to feed the filter cake back into the storage container, such that the filter cake can be supplied together with the particulate solids for further processing.

According to an embodiment of the apparatus, the dry filter is a sintered porous metal filter, a ceramic filter or a bag filter. Filters of this type are distinguished by high permissible operating temperatures, and therefore complicated cooling devices and thus a large amount of energy are not required.

According to a further embodiment, the storage container comprises ports for purging the particulate solids and/or the filter cake with inert gas, in particular nitrogen. The purging with inert gas ensures that the particulate solids do not oxidize, in particular if they are still at relatively high temperatures, and improves the flow behavior of the particulate solids and of the filter cake.

According to various embodiments, pulse lines and pressure measurement devices for measuring the pressures upstream and downstream of the dry filter or for determining a differential pressure are provided, wherein the differential pressure is supplied to a controller and used to control the backwashing device. On the basis of the differential pressure, the controller can be used to control or initiate the backwashing of the dry filter, and therefore the dry filter is returned to the initial operating state and malfunctions of the filter are ruled out.

According to a further embodiment, a controller for controlling an alternate supply of the particulate solids by means of the gas stream and the supply of backwashing gas is provided. The various operating states can be initiated by means of the controller.

The method according to various embodiments serves for separating particulate solids from a gas stream, in particular a carrier gas stream for transporting particulate solids. The gas stream is initially fed by means of a transport line into a separating chamber, where at least partial separation of the particulate solids takes place owing to gravitational force. Then, the now at least partially cleaned gas stream is supplied to a connected dry filter for separating the remaining solids in dust and/or finely particulate form, wherein the cleaned gas stream is discharged from the dry filter by means of a discharge line and the separated particulate solids are supplied to a storage container. Wet filter processes are completely unnecessary owing to the method according to various embodiments. The solids in dust or finely particulate form deposited on the filter remain in the process since they are added to the particulate solids, and these can be kept in a storage container under a special, usually non-oxidizing atmosphere. It is therefore possible for the filter cake to be further processed together with the particulate solids without further measures being taken. Additional conditioning measures for the filter cake are therefore completely unnecessary.

The particulate solids and/or the filter cake are/is supplied to a compacting device, in particular an agglomerating device, and/or to a metallurgical unit, in particular a melting unit, for processing the particulate solids and/or the filter cake. This measure means that the particulate solids and the filter cake are further processed together, and therefore it is possible to produce, for example, agglomerates for a subsequent process step. This has the advantage that no separate processing of the filter cake is required and therefore this useful material can also be reused. As an alternative, it is also possible to supply the particulate solids and the filter cake directly or the agglomerates to a melting unit, and to melt these to form, for example, pig iron or primary steel products.

According to an embodiment, a backwashing gas, in particular nitrogen, is fed into the dry filter under pressure, in particular 3 to 6 bar, by means of backwashing devices in order to remove the filter cake, wherein the removed filter cake is supplied to the storage container. The purging of the filter by means of backwashing gas is aimed at the extensive cleaning of the filter elements, e.g. of the filter candles, in which case the purge gas can also be used to set or maintain a non-oxidizing atmosphere in the dry filter, in the separating chamber and in the storage container. The purge gas and the pressure of the purge gas can be varied as required, and it is possible here to use not only nitrogen but also other non-oxidizing gases, e.g. process gases from metallurgical processes, as purge gases.

According to an embodiment, during the cleaning phase, starting with the point in time from which the purge gas is fed into the dry filter, the supply of the gas stream and of the particulate solids is blocked by means of a controller and/or a valve. This measure ensures that the counterflow of the released filter cake falling downward and of the upwardly flowing gas is minimized in the dry filter. The controller can appropriately clock the purging phases or adapt them as required, in which case it is possible to refer to pressure measurements in the dry filter.

A specific configuration of the method provides for the particulate solids to be at least partially reduced iron, iron agglomerates or sponge iron, in particular in finely particulate form. Such iron-containing substances serve as primary products in the production of pig iron or steel. In most cases, successive process steps, such as the reduction of these substances, are associated directly with a melting process, and therefore processing of the still hot iron-containing substances is desired. In order to avoid reoxidation of the already at least partially reduced iron-containing substances, such substances are often transported, or also stored, under non-oxidizing atmospheres or else supplied for briquetting or compaction.

A further embodiment provides for the gas stream to be formed from reduction gas and/or nitrogen or a mixture thereof. By using process gas from the direct reduction, it is possible to utilize both the heat content thereof and also the property thereof as a reducing gas. As an alternative, if required nitrogen can also be admixed to the gas stream and the quantity of gas in the gas stream or the pressure can be adapted.

A further embodiment provides that a differential pressure is measured at the dry filter, and that the backwashing of the dry filter is initiated by means of a controller if a predefined differential pressure level is exceeded. The control makes it possible to set the optimum operating state and therefore the quantity of gas flowing through the dry filter, and therefore the separation at the dry filter and the period of operation between the backwashes can be maximized. Furthermore, it can be determined on the basis of the differential pressure when purging has to be carried out in order to clean the dry filter. A further embodiment provides for the particulate solids to be supplied by means of the gas stream in a batchwise manner, in particular cyclically, and in a controlled manner alternating with the cleaning cycle starting with the supply of purge gas. It can thereby be ensured that the dry filter is cleaned regularly, and therefore the operation of the dry filter can always be ensured. The supply of the particulate solids and of the gas stream is preferably interrupted during the purging of the filter, such that the pressure of the purge gas, at about 3 to 6 bar, results in complete cleaning of the dry filter.

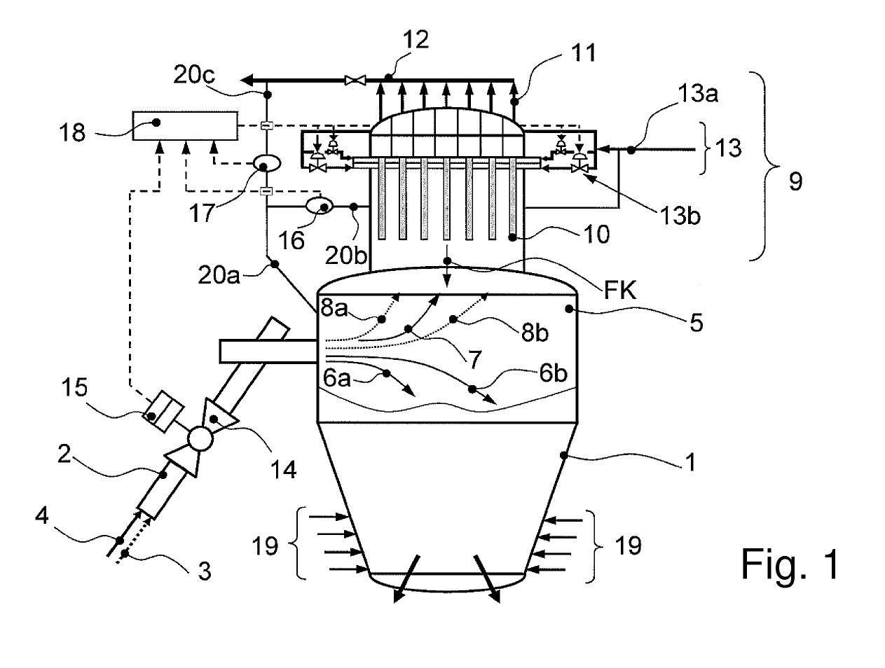

FIG. 1 shows a storage container 1 for particulate solids which is often used for the buffer storage, for example, of directly reduced, particulate iron ores. Said storage container 1 can be connected, for example, to an agglomerating device (not shown) and/or a melting unit (not shown either).

Particulate solids 4 are introduced via a transport line 2 into a separating chamber 5 by means of a carrier gas stream 3. The transport gas line 2 issues into the separating chamber 5 in such a manner that the gas stream or carrier gas stream 3 and the particulate solids 4 are introduced tangentially, with additional separation being achieved owing to centrifugal force, similar to a cyclone.

In the specific configuration according to FIG. 1, the separating chamber 5 is formed by the upper region of the storage container 1. The inflowing gas stream 3 and the particulate solids are separated largely in the separating chamber 5, a large proportion of the particulate solids 6a and 6b being deposited in the storage container 1 owing to gravitational force. In particular dusts, or also finely particulate solids 7, are carried along with the gas stream 8a and 8b into the dry filter 9, where they are separated at the filter elements, in the example shown at a multiplicity of filter candles 10. The cleaned gas stream is discharged from the dry filter via pipes 11 of one or more discharge lines 12 and can be supplied for further use as a cleaned gas.

The dry filter 9 comprises backwashing devices 13, 13a, 13b, which can be used to feed purge gas into the dry filter under excess pressure of about 6 bar counter to the direction of flow of the gas stream, wherein the separated dusts and finely particulate solids which form the filter cake FK can be removed in turn from the filter candles 10 and transferred to the storage container 1. The backwashing device may be in the form of a ring line having a multiplicity of feed-in lines 13a and corresponding shut-off valves 13b.

A valve 14 having an actuating device 15 is provided in the feed line 2, and therefore it is possible to control the supply of the gas stream and of the particulate solids by opening and closing said valve. It is usually the case that the valve 14 is only ever opened briefly by means of the actuating device 15, and the quantity of particulate solids required is conveyed in. As an alternative, largely continuous delivery with short interruptions would also be conceivable.

In order for it to be possible for the current operating state of the dry filter 9 to be sensed in a reliable manner, pulse lines 20a, 20b, 20c and pressure or differential pressure measurement devices 16, 17 and a controller 18 are provided, such that the backwashing of the dry filter 9 can take place on the basis of the measured differential pressure or with further parameters being taken into consideration. It is also possible here for the controller to take account of the switching state of the valve 14 or else to control the latter via the actuating device 15. In order to improve the flow behavior of the particulate solids and of the filter cake in the storage unit 1, ports 19 for purging the particulate solids and the filter cake with inert gas, in particular nitrogen, can also be provided. List of reference symbols
1 Storage container
2 Transport line
3 Gas stream or carrier gas stream
4 Particulate solids
5 Separating chamber
6a, 6b Solids
7 Dusts, finely particulate solids
8a, 8b Gas stream
9 Dry filter
10 Filter candles
11 Pipes
12 Discharge line
13 Backwashing devices
13a Feed-in lines
13b Shut-off valves
14 Valve
15 Actuating device
16, 17 Pressure or differential pressure measurement devices
18 Controller
19 Ports for purging
20a, 20b, 20c Pulse lines

What is claimed is:

1-16. (canceled)

17. An apparatus for separating particulate solids from a carrier gas stream for transporting the particulate solids, comprising at least one transport line which issues tangentially into a separating chamber, a connected dry filter for separating at least one of dusts and finely particulate solids, with a discharge line for discharging the cleaned gas stream, and a storage container for holding the separated particulate solids, wherein the dry filter comprises backwashing devices for separating the filter cake from the dry filter, wherein the dry filter is connected to the storage container in such a manner that the filter cake passes into the storage container, wherein the storage container is a charging container for charging at least one of the particulate solids and the filter cake into an agglomerating device or into a melting unit for processing the particulate solids, wherein the separating chamber is designed in such a manner that the separation takes place not only owing to gravitational force, but also owing to the tangential flow, in a manner similar to that in a cyclone, and wherein the carrier gas stream consists of process gas from a direct reduction, wherein ports for purging the particulate solids and the filter cake with inert gas are provided in the storage container.

18. The apparatus according to claim 17, wherein the transport line has at least one of a controller and a valve for controlling the volumetric flow or the duration of the gas stream and of the particulate solids present therein.

19. The apparatus according to claim 18, wherein the valve is an on/off valve.

20. The apparatus according to claim 17, wherein the dry filter is positioned on the storage container, wherein the separating chamber is formed by the storage container.

21. The apparatus according to claim 17, wherein the dry filter is arranged alongside the storage container, wherein the separating chamber is formed by the lower part of the dry filter.

22. The apparatus according to claim 21, wherein the dry filter has a discharge line for transporting at least one of the separated particulate solids and the filter cake away into the storage container.

23. The apparatus according to claim 17, wherein the dry filter is a sintered porous metal filter, a ceramic filter or a bag filter.

24. The apparatus according to claim 17, wherein pulse lines and pressure measurement devices for measuring the pressures upstream and downstream of the dry filter or for determining a differential pressure are provided, wherein the differential pressure is supplied to a controller and used to control the backwashing device.

25. The apparatus according to claim 17, comprising a controller for controlling an alternate supply of the particulate solids by means of the gas stream and the supply of purge gas.

26. A method for separating particulate solids from a carrier gas stream for transporting particulate solids, wherein these solids are iron-containing primary products for the production of pig iron and steel, the method comprising:
forming the gas stream from non-oxidizing process gas from a direct reduction and
initially feeding the gas stream by means of a transport line into a separating chamber, where at least partial separation of the particulate solids takes place owing to gravitational force, wherein the separating chamber is designed in such a manner that the separation also takes place owing to a tangentially forming flow, in a manner similar to that in a cyclone, and then
supplying the at least partially cleaned gas stream to a connected dry filter for separating the remaining solids in at least one of dust and finely particulate form,
discharging the cleaned gas stream from the dry filter by means of a discharge line, and
supplying the separated particulate solids to a storage container, wherein the filter cake is separated from the filter by a non-oxidizing backwashing gas and supplied to the storage container, wherein at least one of the particulate solids and the filter cake are purged with inert gas via ports in the storage container and charged from the storage container into at least one of an agglomerating device and a melting unit for processing at least one of the particulate solids and the filter cake.

27. The method according to claim 26, wherein a backwashing gas is fed into the dry filter under pressure by means of backwashing devices in order to remove the filter cake, wherein the removed filter cake is supplied to the storage container.

28. The method according to claim 27, wherein the backwashing gas is nitrogen.

29. The method according to claim 27, wherein the pressure is from 3 to 6 bar.

30. The method according to claim 26, wherein, during the cleaning phase, starting with the point in time from which the purge gas is fed into the dry filter, the supply of the gas stream and of the particulate solids is blocked by means of at least one of a controller and a valve.

31. The method according to claim 26, wherein the particulate solids are at least partially reduced iron, iron agglomerates or sponge iron.

32. The method according to claim 31, wherein the at least partially reduced iron, iron agglomerates or sponge iron are in finely particulate form.

33. The method according to claim 26, wherein the gas stream is formed from at least one of reduction gas and nitrogen or a mixture thereof.

34. The method according to claim 26, wherein a differential pressure is measured at the dry filter, and the backwashing of the dry filter is initiated by means of a controller if a predefined differential pressure level is exceeded.

35. The method according to claim 26, wherein the particulate solids are supplied by means of the gas stream in a batchwise manner and in a controlled manner alternating with the cleaning cycle starting with the supply of purge gas.

36. The method according to claim 26, wherein the particulate solids are cyclically supplied by means of the gas stream and in a controlled manner alternating with the cleaning cycle starting with the supply of purge gas.
